(19) United States
(12) Patent Application Publication
(10) Pub. No.: US 2026/0161900 A1
(43) Pub. Date: Jun. 11, 2026

(54) CROSS-LINGUAL HUMAN-PREFERENCE ALIGNMENT FOR NEURAL MACHINE TRANSLATION WITH DIRECT QUALITY OPTIMIZATION

(71) Applicant: Lilt, Inc., Emeryville, CA (US)

(72) Inventors: Kaden Uhlig, Berlin (DE); Joern Wuebker, Stanford, CA (US); Raphael Reinauer, Berlin (DE); John DeNero, Stanford, CA (US)

(21) Appl. No.: 19/345,011

(22) Filed: Sep. 30, 2025

Related U.S. Application Data
(60) Provisional application No. 63/729,149, filed on Dec. 6, 2024.

(51) Int. Cl. G06F 40/51; G06F 40/58; G06N 3/092

(52) U.S. Cl. CPC G06F 40/51; G06F 40/58; G06N 3/092

(57) ABSTRACT

Reinforcement Learning from Human Feedback (RLHF) and derivative techniques like Direct Preference Optimization (DPO) are task-alignment algorithms used to repurpose general, foundational models for specific tasks. Applying task-alignment to neural machine translation (NMT) addresses an existing task-data mismatch in NMT, leading to improvements across all languages of a multilingual model, even when task-alignment is only applied to a subset of those languages. In an embodiment, such improvements are provided by introducing Direct Quality Optimization (DQO), a variant of DPO leveraging a pre-trained translation quality estimation model as a proxy for human preferences. The improvements can be verified with both automatic metrics and human evaluation.

### CROSS-REFERENCE TO RELATED APPLICATION

This application claims priority to provisional application 63/729,149, filed Dec. 6, 2024, the entire contents of which are hereby incorporated by reference for all purposes as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. © 2024-2025 Lilt, Inc.

### BACKGROUND

### 1. Background and Introduction

The approaches described in this section are approaches that could be pursued, but not necessarily approaches that have been previously conceived or pursued. Therefore, unless an approach is expressly identified as “prior art,” it should not be assumed that any of the approaches described in this section qualify as prior art merely by virtue of their inclusion in this section.

Neural machine translation (NMT) is an approach to machine translation that uses a large neural network. It departs from phrase-based statistical translation approaches that use separately engineered subcomponents, which are then weighted either manually or according to an optimization criterion. In contrast, neural machine translation models use deep learning and representation learning. They typically require less memory than traditional statistical machine translation models since they do not require either a large target-side language model or a translation model that is proportional to the training data size. Furthermore, unlike conventional statistical machine translation systems, all parts of the neural translation model are trained jointly (end-to-end) to maximize the translation accuracy. A bidirectional recurrent neural network, known as an encoder, is used by the neural network to encode a source sentence for a second recurrent neural network, known as a decoder, which is used to predict words in the target language. Alternatively, convolution neural networks or feed-forward networks may be used.

For many natural language generation (NLG) tasks, aligning models to human preferences has led to large performance gains (Ziegler et al., 2020). A strong motivation for this alignment step is that much of the data on which the model was originally trained—internet text—is useful for language generation in general, but does not match the desired output for the task. NMT models have not involved alignment to human preferences, in part because of the assumption that supervised training data for NMT does match the desired output of the translation task. However, we show the existence of a mismatch between the NMT task and typical training data.

Throughout this disclosure, the term “we” is used for convenience and/or as shorthand; all such references should be interpreted as meaning “this disclosure” or referring to the techniques of the present disclosure and not meaning one or more particular persons or entities.

Machine translation is unusual among NLG tasks in that task-relevant supervised training data—text paired with its translation—is plentiful and publicly available. One might expect that with such a large amount of task-relevant training data, there would be no need for task alignment. However, we identify an exhaustive list of reasons why training examples in a parallel corpus diverge from the desired output in meaningful ways (see Section 2.2).

Machine translation is also unusual in that human preference data has been collected and published for a large number of systems, and translation quality estimation (QE) is an active research area that has benefited greatly from recent advances in large language models. We introduce a method for using quality estimation models, which themselves are trained from human preference data, to perform NMT task alignment. Our method, Direct Quality Optimization (DQO), is a batched online variant of Direct Preference Optimization (DPO) (Rafailov et al., 2023) that uses a QE model as a proxy for human preference.

We show that DQO improves translation quality in terms of BLEU, COMET, CometKiwi, and BLEURT, and leads to a reduction in translation errors in a human evaluation using the Multidimensional Quality Metric framework (MQM) (Lommel et al., 2014; Freitag et al., 2021).

We make three notable observations when applying DQO to a multilingual model:

Task alignment increases task performance and human preference while also increasing the distance between the model's output distribution and the training data distribution.

Improvements carry over to held-out languages and language families, which were not contained in the data used for DQO.

Improvements in held-out languages are not limited to general behaviors required by the translation task (e.g., avoiding source language fragments, translation additions and omissions), but include language-specific linguistic features not seen in the DQO alignment data, such as transliteration of named entities in Latvian.

While we attribute much of the performance in held-out languages to transfer learning of general behaviors required by the translation task (such as avoiding source language fragments and translation additions, omissions, or inconsistencies), the language-specific improvements in held-out languages cannot be explained by transfer learning.

Instead, these results suggest that DQO not only increases the likelihood of the features present in its task alignment data, but also focuses the model on human preference features that it already learned during supervised training.

### BRIEF DESCRIPTION OF THE DRAWINGS

In the drawings:

FIG. 1A illustrates a computer-implemented process of Direct Quality Optimization (DQO).

FIG. 1B illustrates a generalized embodiment of a computer-implemented process of Direct Quality Optimization (DQO).

FIG. 2 illustrates an example of results of executing the process of FIG. 1B.

FIG. 3 illustrates a computer system that can be used to implement an NMT system in one embodiment.

FIG. 4 is a block diagram that illustrates an example computer system with which an embodiment may be implemented.

### SUMMARY OF THE INVENTION

The appended claims may serve as a summary of the invention.

### DETAILED DESCRIPTION

### 2. The Task-Data Mismatch in NMT

In the following description, for the purposes of explanation, numerous specific details are set forth to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other unless expressly specified otherwise. In addition, devices that communicate with each other may communicate directly or indirectly through one or more intermediaries, logical or physical.

A description of an embodiment with several components in communication with one another does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order that is practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment, but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in the singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 2.1 Task: Human-Preferred Translations

Like many NLG tasks, NMT is an open-ended problem, with multiple valid outputs for any given input, each preferred more or less by humans depending on a variety of factors, including adequacy, fluency, context, tone, style, and many other subtle features.

Because of this, the task of NMT cannot be reduced to producing valid translations, nor human-like translations, but instead requires generating human-preferred translations-those judged as at least as good as all other valid translations.

### 2.2 Training Data Mismatch

The supervised training data used in NMT comes from a variety of sources, each with notable differences from the task distribution of human-preferred translations.

### 2.2.1 Web Data Mining

A large portion of parallel data is mined from massive collections of web documents, using automated methods to detect and align source and target language segments—the popular datasets ParaCrawl (Bañón et al., 2020) and CCMatrix (Schwenk et al., 2021b), for example. This process may capture human translations, text written independently in both the source and target languages on the same topic, or the output of other MT models.

One prominent cause of a task-data mismatch in automatically aligned sentence pairs is semantic misalignment. Kreutzer et al. (2022) found semantic misalignment in 15% (ParaCrawl) and 32% (CCMatrix) of sentence pairs as part of a manual quality audit.

The simplest form is complete semantic misalignment when the source and target segments are completely unrelated. This certainly contributes to any task-data mismatch, but such pairs are easy to detect with tools such as BiCleaner (Ramírez-Sánchez et al., 2020) or reference-free quality evaluation models such as CometKiwi Peter et al. (2023).

Unfortunately, slight semantic misalignments of source and target are both more prevalent and much more difficult for state-of-the-art filtering systems to detect Meng et al. (2024). These may include subtle yet significant differences in meaning, factual differences in numbers or names, additions and omissions, and the accompanying losses in translation adequacy.

In addition, these segments often still contain useful information that may help the model learn Meng et al. (2024).

### 2.2.2 Accidental Inclusion of Machine-Translated Content

Web data may also include the outputs of other machine translation models, including neural, statistical and dictionary-based methods of varying quality. The impact of training on low-quality machine translations is clear; however, even good NMT systems' outputs differ significantly enough from natural text that classifiers can be trained to detect machine-translated text with high accuracy- and even predict which machine translation system was used to translate a given text (La Morgia et al., 2023).

Recent research suggests that up to 57% of translations mined from the web are multi-way parallel, meaning parallel translations of a segment can be found in more than two languages, and demonstrates a strong correlation between multi-way parallelism and low-quality translations likely to be machine-translated (Thompson et al., 2024). The authors also found that multi-way parallel translations follow a distinct distribution, focused on low-quality content typically used for search engine optimization.

### 2.2.3 Translator Skill Level

Another source of task-data mismatch in human translations is the fact that human translators differ in skill level Albir (2017). This implies that not all human translations will be equally preferred by humans.

Achieving mean human quality in translations is not the task of NMT, as defined in Section 2.1. We propose that neither is the maximum human quality. In theory, it is conceivable that humans prefer machine-generated translations over even the best translations. Therefore, we do not want finite human skill to impose an upper limit on translation quality.

### 2.2.4 Translationese

Another significant issue is a phenomenon known as translationese, the observation that human-translated texts in a given language differ in distribution from texts written independently in that language. Specifically, translated text shows signs of interference from the source language's grammar, word order and word choice, as well as source language-independent effects of the translation process itself, such as simplification and avoidance of unique language features (Koppel and Ordan, 2011; Laviosa, 1998; Tirkkonen-Condit, 2004).

These effects are significant enough that classification models can distinguish translated and original text with high accuracy (Baroni and Bernardini, 2005; Sominsky and Wintner, 2019), as well as identify the source language of the text (Koppel and Ordan, 2011).

As humans show a consistent preference for translations closer to the distribution of original text rather than translationese (Riley et al., 2020; Freitag et al., 2022), this creates an inherent task-data mismatch for training data translated in the source-target direction.

### 2.2.5 Source-Target Domain Mismatch

Translation pairs in the other direction, target-source, are better aligned with human preference, as the target labels are drawn from the original text distribution rather than from translationese.

Unfortunately, they suffer from another subtle source of task-data mismatch found in human translations: source-target domain mismatch (Shen et al., 2021).

Source-target domain mismatch is the observation that speakers of different languages tend to discuss different topics. For instance, a Cherokee newspaper is likely to report on different topics than an Icelandic newspaper would, and translations of these articles would remain representative of the Cherokee or Icelandic language domains, respectively.

This effect is especially pronounced for low-resource language pairs (Shen et al., 2021).

If one were to avoid the task-data mismatch of translationese by using only target-source translation pairs, the training data may lack key information about topics found only in the source domain. Because the task is translation from the source domain into the target language, this, too, would represent an unavoidable task-data mismatch.

### 3. Human Preference Learning for LLMs

Supervised data showing chat-based dialog between humans and AI assistants was, prior to the wide availability of such agents in the form of LLMs, understandably rare. The only possible method of creating such data was to hire humans to role-play as AI assistants—an expensive endeavor that few research teams had the funding or time to undertake. Even with the advent of high-quality proprietary and open-source models, which one could sample to create synthetic data, there is a fundamental task-data mismatch: the task is not to imitate an existing AI assistant, but (ideally) to train a new state-of-the-art model.

LLM training instead follows a two-step process:
(1) Supervised learning on massive amounts of web data.
(2) Task alignment using instruction fine-tuning and human preference learning.

In step one, the model is optimized to predict the next token in documents taken from the web. When done at scale and with a variety of data sources, this provides the model with extensive world knowledge and understanding of a wide array of styles and document types.

This is then followed by instruction fine-tuning, a comparatively brief round of supervised learning on human or AI-labeled examples of dialogues, which brings the model's output distribution into the general neighborhood of desired behavior. Finally, human preference learning, using actual human rankings, aligns the model with the desired task: producing human-preferred responses to questions and dialog while remaining helpful and harmless (Bai et al., 2022).

Direct Preference Optimization (DPO) is a preference learning algorithm that trains on preference pairs of the form (x,yw,yl), with x being a model input, and yw and yl being two potential model outputs for the input x, marked as chosen (winning) or rejected (losing) by humans during data collection (Rafailov et al., 2023), using the loss function:

$${ℒ}_{D P O} ( x , {y}_{w} , {y}_{l} ) = log σ ( β log \frac{{π}_{θ} ( {y}_{w} \vert x )}{{π}_{ref} ( {y}_{w} \vert x )} - β log \frac{{π}_{θ} ( {y}_{l} \vert x )}{{π}_{ref} ( {y}_{l} \vert x )} )$$

where σ is the logistic function.

### 4. Direct Quality Optimization for NMT

Because of its stability and ease of use, we select DPO as the basis for our experiments with human preference learning as a form of task alignment. As a proxy for human preferences, we use the CometKiwi quality estimation model to score and compare multiple translations of a given source Rei et al. (2022). CometKiwi is highly multilingual and has been shown to correlate well with human preference Kocmi et al. (2024).

Our experiments are run with the NVIDIA Megatron English-Many model (available at the time of this writing via the online document at the internet domain catalog.ngc.nvidia.com via the folder path/orgs/nvidia/teams/nemo/models/megatronnmt_en_any_500m), a 500 M parameter encoder-decoder model, which supports translating from English into 30 languages (the model was originally trained to support 32 languages, but we found that translating into Arabic and Slovak resulted in degenerate output) from 14 language families, listed in Table 1. We denote the complete list of supported target languages as [symbol] .

TABLE 1
Target languages supported by the NVIDIA Megatron model.

| Language Family | Languages (ISO 639-1) |
|---|---|
| Baltic | lt, lv |
| Germanic | da, de, nl, no, sv |
| Romance | es, fr, it, pt, ro |
| Slavic | bg, cs, hr, pl, ru, sl, uk |
| Uralic | et, fi, hu |
| Other | el, hi, id, ja, ko, tr, vi, zh |

The category “Other” contains all languages that are the only supported representative of their language family. The languages on which we apply task alignment are in boldface.

The model's multilingual nature allows us to apply task alignment to a subset of language pairs and observe the effects on unrelated languages, with minimal risk of exposing the model to any new information in those languages.

Any improvements in those languages must either apply to all languages (such as avoiding omissions or additions) or be language-specific, and can only have come from previously unused latent knowledge from supervised training.

In our experiments, we selected Chinese, German, Hindi, Russian and Spanish as the target languages used during task alignment, termed [symbol] ={de,es,hi,ru,es}. Let [symbol] C= [symbol] \ [symbol] be the set containing the 25 target languages not represented during task alignment, R be the set of languages related to at least one language in [symbol] , and [symbol] C= [symbol] \ [symbol] be the languages unrelated to any of the languages used in task alignment. An overview of how many languages belong to each set is shown in Table 2.

TABLE 2
Target languages supported by the NVIDIA Megatron
EN-X model, categorized by their relationship
with the languages selected for task alignment.

| Subset | Definition | Size |
|---|---|---|
| [symbol] | Languages seen in DQO | 5 |
| [symbol] C | Languages not seen in DQO | 25 |
| [symbol] | Languages related to [symbol] | 19 |
| [symbol] C | Languages unrelated to [symbol] | 11 |

As the seed dataset from which to draw source sentences for human preference learning, we use the source side of a mixture of publicly available English-German MT datasets (listed in Appendix A.3), with the goal of covering a wide range of source domains.

From this dataset, we sample 8000 source segments. For each source segment, we sample a target language from [symbol] , the languages used for task alignment, and use the current policy model to sample 64 translations into that language using combined Top-K and Top-P sampling, with K=40, P=0.8 Fan et al. (2018); Holtzman et al. (2020). We also add the greedy translation for each source segment, obtaining a total of 520,000 translations.

Letting the output of the CometKiwi Quality Estimation (QE) model for a source x and translation y be r_{QE} (x,y), we build a relation [symbol] x as a proxy for true human preferences:

$${y}_{1} {≻}_{x} {y}_{2} ≡ {r}_{Q E} ( x , {y}_{1} ) > {r}_{Q E} ( x , {y}_{2} ) + ε$$

where ε≥0 is a tolerance parameter to help mitigate proxy model noise. We set ε=0.005.

To construct preference pairs, we then select the highest-scoring translation per source segment as y_{w} and uniformly sample y₁ from all remaining translation candidates that satisfy y_{w} [symbol] y₁ under our proxy model.

This results in slightly under 8000 preference pairs (occasionally the maximum difference in COMET score between a segment's highest and lowest scoring sampled translations is less than ε, in which case we do not produce a preference pair), we run DPO training with a batch size of 8192 tokens (counting source, chosen and rejected tokens), a learning rate of 1e-6 and β=0.5. A complete list of hyperparameters can be found in Appendix 7.

At this point, we train on the preference pairs using standard DPO for 8 epochs, after which we sample a fresh set of source segments from the seed dataset, sample translations from the policy model, create a new set of preference pairs, and begin the training again. This helps ensure that the preference pairs used are relevant to the policy model throughout training.

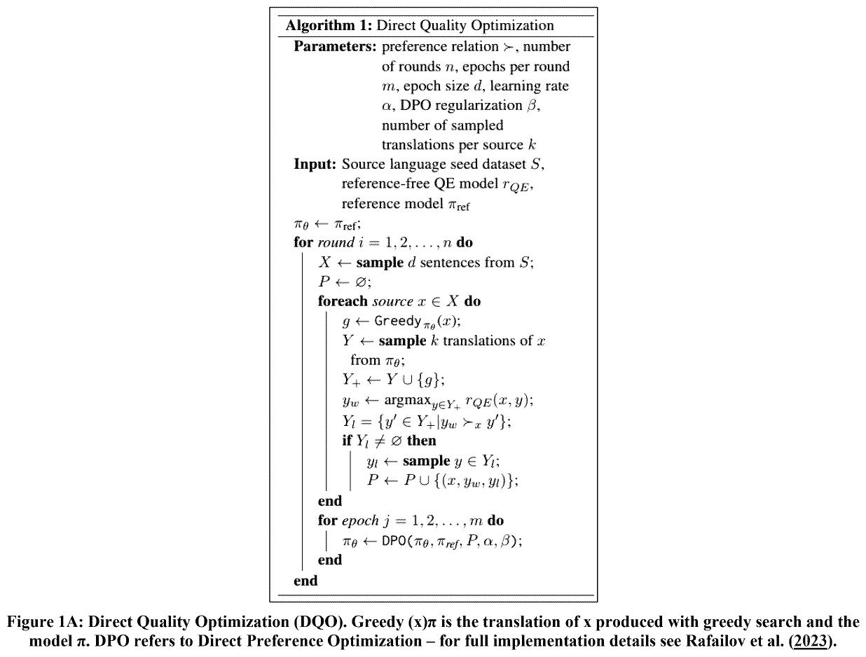

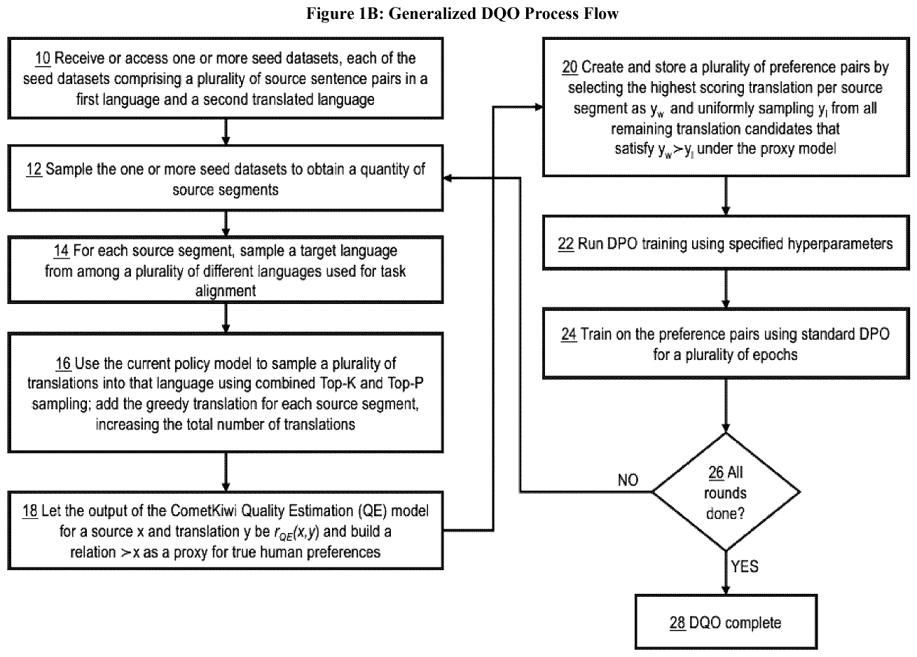

In total, we perform 6 such rounds of DPO training. We call this end-to-end process Direct Quality Optimization (DQO), detailed formally in FIG. 1A and Algorithm 1, Direct Quality Optimization. FIG. 1A illustrates a computer-implemented process of Direct Quality Optimization (DQO). This can be viewed as a batched online version of DPO, as the updates are performed on batches of data sampled from the policy model. Initial experiments showed that performance gains rapidly plateaued under standard DPO with a static dataset of preference pairs.

TABLE 3
Evaluation metrics on FLORES+ and NTREX with the NVIDIA Megatron EN-X model, before and
after task-alignment using DQO. Results are shown for relevant groupings of the 30 target languages:
all languages, languages used in DQO ( [symbol] ), languages not used in DQO ( [symbol] ^{c}), languages
not used in DQO but related to those used ( [symbol] ∩ [symbol] ^{c}), and languages neither
used nor related to the languages used ( [symbol] ^{c}).

| | | FLORES+ | | | | NTREX | | | |
|---|---|---|---|---|---|---|---|---|---|
| Model | Lang. | BLEURT | COMET | CometKiwi | BLEU | BLEURT | COMET | CometKiwi | BLEU |
| Baseline | All | 0.7732 | 0.8787 | 0.8451 | 34.33 | 0.7127 | 0.8414 | 0.8169 | 30.76 |
| DQO | All | 0.7928 | 0.8923 | 0.8585 | 35.45 | 0.7354 | 0.8593 | 0.8344 | 31.68 |
| Baseline | [symbol] | 0.7329 | 0.8467 | 0.8334 | 34.88 | 0.6795 | 0.8120 | 0.8070 | 33.19 |
| DQO | [symbol] | 0.7498 | 0.8615 | 0.8478 | 35.51 | 0.7009 | 0.8309 | 0.8256 | 33.74 |
| Baseline | [symbol] c | 0.7812 | 0.8851 | 0.8475 | 34.22 | 0.7193 | 0.8473 | 0.8189 | 30.27 |
| DQO | [symbol] c | 0.8014 | 0.8985 | 0.8606 | 35.43 | 0.7422 | 0.8650 | 0.8362 | 31.27 |
| Baseline | [symbol] ∩ [symbol] c | 0.7909 | 0.8864 | 0.8510 | 36.58 | 0.7297 | 0.8478 | 0.8213 | 33.44 |
| DQO | [symbol] ∩ [symbol] c | 0.8080 | 0.8979 | 0.8624 | 37.61 | 0.7508 | 0.8648 | 0.8377 | 34.58 |
| Baseline | [symbol] c | 0.7689 | 0.8833 | 0.8431 | 31.22 | 0.7061 | 0.8465 | 0.8158 | 26.23 |
| DQO | [symbol] c | 0.7930 | 0.8992 | 0.8583 | 32.66 | 0.7313 | 0.8652 | 0.8342 | 27.05 |

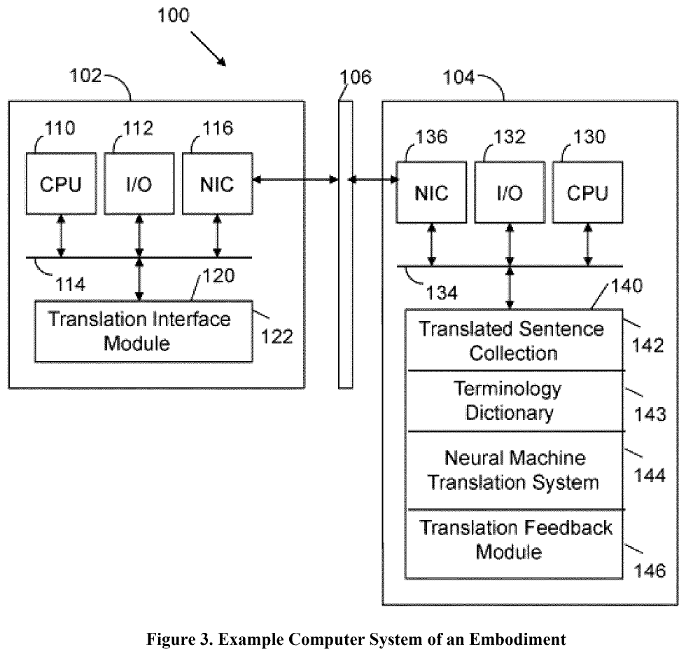

As illustrated in FIG. 1B, the foregoing process can be generalized as the following method. FIG. 1B illustrates a generalized embodiment of a computer-implemented process of Direct Quality Optimization (DQO). The method can be computer-implemented, and each block of FIG. 1B can be executed using instructions forming part of the NMT system 144 of FIG. 3, which is described further below. Referring to FIG. 1B:

Block 10—Receive or access one or more seed datasets, each of the seed datasets comprising a plurality of source sentence pairs in a first language and a second translated language.

Block 12—Sample the one or more seed datasets to obtain a quantity of source segments.

Block 14—For each source segment, sample a target language from among a plurality of different languages used for task alignment.

Block 16—Use the current policy model to sample a plurality of translations into that language using combined Top-K and Top-P sampling. Add the greedy translation for each source segment, increasing the total number of translations.

Block 18—Let the output of the CometKiwi Quality Estimation (QE) model for a source x and translation y be r_{QE} (x,y) and build a relation [symbol] x as a proxy for true human preferences.

Block 20—Create and store a plurality of preference pairs by selecting the highest scoring translation per source segment as y_{w}, and uniformly sample y₁ from all remaining translation candidates that satisfy y_{w} [symbol] y₁ under the proxy model, yielding a few thousand preference pairs.

Block 22—Run DPO training using specified hyperparameters.

Block 24—Train a machine-learning policy model on the preference pairs using standard DPO for several epochs.

Block 26—Test whether a specified number of iterations or rounds is complete. If not, return to step 2 (block 12) in a plurality of iterations. An example is 6 such rounds of training. If all rounds are complete, then DQO is complete at block 28 and control can return to another process or terminate.

### 5. Experimental Results

### 5.1 Automatic Quality Metrics

We evaluated the model pre- and post-task alignment on the FLORES+ (Team et al., 2024) and NTREX (Federmann et al., 2022; Barrault et al., 2019) datasets, both of which cover all of the languages supported by the Megatron model.

We use corpus-level sacreBLEU (Signature: nrefs:1|case:mixed|eff:no| tok:13a|smooth:exp|version:2.4.0. For JA and ZH, we additionally use the mecab-ja and mecab-zh tokenizers) (Post (2018)) as well as three neural evaluation models:

Reference-free CometKiwi (Rei et al., 2022b)

Reference-based COMET (Rei et al., 2022a)

### BLEURT (Sellam et al., 2020)

It is important to note that the CometKiwi model was used as a proxy for human preferences in this experiment and was thus directly optimized. The scores from the other two neural evaluation models are thus more reliable measures of general model quality and allow us to check for reward hacking, i.e., over-optimization for the CometKiwi model at the cost of performance.

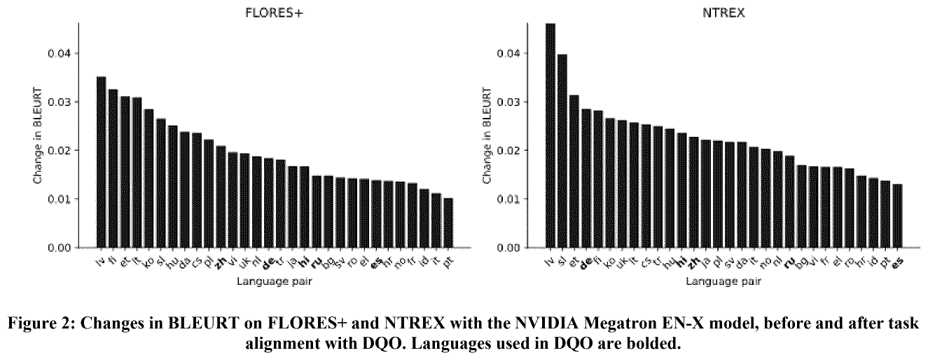

Results are reported in Table 3 and FIG. 2. FIG. 2 illustrates an example of results of executing the process of FIG. 1B. We find that DPO task alignment increases all three neural quality metrics on both datasets for each of the 30 target languages supported by the Megatron EN-X model.

BLEU scores increased for all languages on both datasets, except for Hindi, which decreased by 0.70 BLEU on NTREX and 1.12 BLEU on FLORES+, despite showing improvements on the three neural metrics, like all other languages. The exact cause of this exception is unclear, especially as Hindi was one of the five languages used for DPO task alignment.

Significantly, translation quality, as measured by all four translation quality metrics, improved even for target languages unrelated to the languages used in DPO task alignment. See Appendix A.4 for the metrics for each individual language.

### 5.2 Training Data Perplexity

To confirm the existence of a task-data mismatch, we examine how DQO affects the model's perplexity on the training data. As we do not have access to the training data used for the NVIDIA Megatron English-Many model, we repeat the above experiment with a proprietary encoder-decoder model trained on publicly available English-to-German data using the NVIDIA NeMo framework (Kuchaiev et al., 2019). For the full list of training datasets, see Appendix A.3.

The model architecture is similar to the Megatron model, with both following the deep encoder, shallow decoder recipe suggested by Kasai et al. (2021). However, the Megatron model is significantly larger, with an embedding size of 2048, a feed-forward width of 8192, 21 encoder layers and 2 decoder layers, and a 32768 token vocabulary, resulting in a total of 1.3B parameters.

We apply DQO to this model as with the Megatron model, however, using only English-German preference pairs.

After applying DQO, we see large improvements in CometKiwi and COMET for a variety of evaluation datasets, confirming that DQO worked as expected.

The arithmetic mean of perplexity over a random sample of 1 million segments from the training data increased from 7.219 (baseline model) to 9.435 (DQO), confirming that the improvements in preference are not due to increased ability to model the training data.

### 5.3 Discussion

The nearly-universal improvements for both FLORES+ and NTREX in all four automatic translation quality metrics (Table 3) provide strong evidence that DQO is a suitable task-alignment algorithm for the task of producing human-preferred translations. The only language that did not see universal improvements was Hindi, which regressed in BLEU for both datasets, despite improving in the three neural metrics (COMET, CometKiwi, and BLEURT). Improvements for both FLORES+ and NTREX in all four automatic translation quality metrics (Table 3) provide strong evidence that DQO is a suitable task-alignment algorithm for the task of producing human-preferred translations.

As shown in Section 5.2, while improving task performance, DQO increases perplexity over the training data used during supervised training. This, combined with the finding that DQO is a suitable task alignment algorithm, is evidence for the existence of the task-data mismatch.

Much of this improvement can likely be credited to general, language-agnostic changes in model behavior, even with the restriction to using only 5 of the 30 supported target languages in DQO. If task alignment of a model with a given target language reduces the likelihood of untranslated source text, for instance, it would not be surprising to see similar improvements in other target languages.

Similarly, if task alignment for a given target language led to language-specific improvements (e.g., in grammar, sentence structure, punctuation, general fluency, etc.), it seems plausible that transfer learning could lead to improvements in closely related languages that have similar features.

However, manual inspection of translations before and after DQO revealed language-specific improvements in unrelated languages. In Latvian, for instance, foreign names are transliterated to match Latvian orthography and declined for grammatical case and gender, e.g., Klavinska (2021) reports that George Clooney is translated as Džordžs Klūnijs. While the baseline model applies this rule occasionally and inconsistently, we verified with a native speaker that the DQO model almost always produces the correct transliteration. Examples produced by the DQO model include transliterating Deng Xiaoping in the genitive case as Dena Sjaopina, or Louis Jourdain in the nominative case as Luiss Džordēns.

TABLE 5
Mean number of Multidimensional Quality Metrics (MQM) errors per segment, as
annotated by professional human evaluators, with two different groupings:
by severity and by whether the MQM subcategory is language specific or agnostic.
NT stands for non-translation, i.e., a segment that cannot be construed as
a translation of the source. Trivial refers to minor punctuation errors. This
covers 100 randomly sampled English segments from the FLORES+ dataset,
translated by the NVIDIA Megatron model before task alignment (baseline) and
after it (DQO). The weighted MQM score follows Freitag et al. (2021).

| | | Severity | | | | Language Specific | | | Weighted |
|---|---|---|---|---|---|---|---|---|---|
| Language | Model | NT | Major | Minor | Trivial | Yes | No | N/A | MQM ↓ |
| Japanese | Baseline | 0 | 1.15 | 0.61 | 0.06 | 1.28 | 0.50 | 0.01 | 6.256 |
| | DQO | 0 | 0.93 | 0.63 | 0.03 | 1.16 | 0.40 | 0.01 | 5.223 |
| Lithuanian | Baseline | 0.03 | 0.95 | 0.89 | 0.12 | 1.48 | 0.51 | 0 | 6.402 |
| | DQO | 0.01 | 0.80 | 0.77 | 0.10 | 1.24 | 0.44 | 0 | 5.030 |

As DQO was only performed on Chinese, German, Hindi, Russian or Spanish, none of which are closely related to Latvian, this behavior cannot have been learned from scratch during DQO. Although Chinese, Hindi, and Russian also transcribe foreign names, they use non-Latin scripts.

One possible explanation is that the baseline model learned to model both transliteration and non-transliteration due to the range of translation quality in its supervised training data, causing inconsistent behavior at inference time. When DQO then shifts the output distribution towards general high-quality behaviors, the probability of any correlated behaviors (e.g., transliteration in Latvian) would also increase.

### 5.4 Human Evaluation

To verify the presence of further language-specific changes for unrelated languages, we performed a human evaluation using the Multidimensional Quality Metrics framework (MQM) with professional translators (Lommel et al., 2014; Freitag et al., 2021). The translators were trained on MQM and Anthea (available at the time of this writing at the internet domain github.com via the network pathname/google-research/google-research/tree/a676d87/anthea), the open-source tool we used for performing MQM.

We follow Freitag et al. in weighting major non-translations at 25 MQM points, other major errors at 5, and all minor errors at 1, except minor punctuation errors, which are 0.1 points.

For analysis, we selected two target languages not closely related to the languages used for task alignment: Lithuanian and Japanese.

These were selected to provide one low-to-medium resource language written in the Latin script and one in a non-Latin script, because neither is an outlier in quality metric improvement compared to the other supported language pairs, and to avoid the bias of examining Latvian, which we had already manually inspected.

For each language, we sampled complete documents (each generally two to five sentences forming a single paragraph) from FLORES+ until we had 100 source segments and translated them with the baseline and task-aligned models. These translations were shown with document context (i.e., keeping related segments together) to the translators, who then annotated them.

We then sorted the MQM error subcategories into two buckets, language agnostic and language specific, as seen in Table 6 in Appendix A.1.

We observe reduced error rates in both Japanese and Lithuanian in both the language-agnostic and language-specific categories (Table 5). The overall weighted MQM score also decreased for both languages, with significant improvements in both Lithuanian (pu=0.001) and Japanese (pu=0.012), where pu-values are conservative estimates of the true p-values computed using paired one-sided approximate randomization (Phipson and Smyth, 2010) with the Marot toolkit (available online at the time of this writing at the internet domain github.com via the networked pathname/google-research/google-research/tree/a676d87/marot/README.md).

### 5.5 Example Implementation Context

NMT systems are described generally and in forms adapted for specific tasks and goals in U.S. Pat. Nos. 10,346,548; 10,878,201; 11,361,170; 11,625,546; 11,783,136; 11,900,073; US Pat. Pub. No. 20230394251A1; and US Pat. Pub. No. 20240095470. The computer systems and software architectures of the foregoing disclosures can be modified to implement embodiments of the techniques of the present disclosure. This disclosure is directed to persons who are familiar with the foregoing disclosures and who have the education, experience, and skill to design, code, build, and test similar systems.

FIG. 3 illustrates a computer system that can be used to implement an NMT system in one embodiment. In an embodiment, the system 100 includes a client device 102 in communication with a server 104 via a network 106, which may be any combination of wired and wireless networks.

Client device 102 may be a computer, tablet, smartphone or the like. The client device 102 includes a processor (e.g., a Central Processing Unit or CPU) 110 and input/output devices 112 connected via a bus 114. The input/output devices 112 may include a keyboard, mouse, touch display and the like. A network interface circuit 116 is also connected to the bus 114. The network interface circuit 116 provides connectivity to the network 106. A memory 120 is also connected to the bus 114. The memory stores a translation interface module 122, which includes instructions executed by processor 110. The translation interface module 122 includes instructions to communicate with server 104 to obtain an interface that accepts a phrase in a source language. The phrase in a source language is communicated to the server 104 to obtain a translation of the phrase to a target language. The translation interface module 122 also includes instructions executed by the processor 110 to display the translation and solicit input on the quality of the translation.

Server 104 includes a processor 130, input/output devices 132, a bus 134 and a network interface circuit 136. A memory 140 is connected to bus 134. The memory 140 stores instructions to implement operations associated with the invention. In particular, the memory 140 stores a translated sentence collection 142. The translated sentence collection is a corpus of phrases in a source language and corresponding phrases in a target language.

The memory also stores a terminology dictionary 143. A terminology dictionary is important to human translators. A terminology dictionary is a list of source words and phrases and their translations. Typically, the terminology dictionary differs from the corpus (e.g., translated sentence collection 142) on which the neural machine translation system is trained only in the length of source sentences included in the data. Dictionary entries tend to be shorter in length than the full sentences included in the training data on which the neural machine translation system is trained. The terminology dictionary 143 has tailored translations that the human translator is likely to invoke.

The memory 140 also stores a neural machine translation system 144, the operations of which are discussed in detail below. The memory 140 also stores a translation feedback module 146 with instructions executed by the processor 130 to communicate to the client device a translated phrase.

Memory 140 can be a computer storage product with a computer-readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming languages and development tools. Another embodiment of the invention may be implemented in hardwired circuitry in place of, or in combination with, machine-executable software instructions.

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

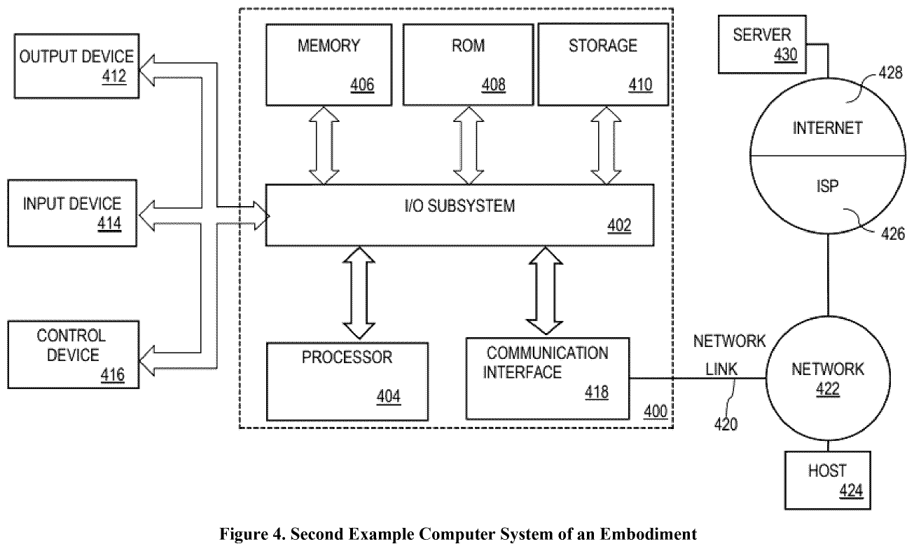

FIG. 4 is a block diagram that illustrates an example computer system with which an embodiment may be implemented. FIG. 4 represents a more detailed view of computer system 400 that can implement the client device 102 of FIG. 3 in communication with server 430, like server 104 of FIG. 3, while omitting for clarity elements 122 and 1440-146 of FIG. 3.

In the example of FIG. 4, a computer system 400 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 400 includes an input/output (I/O) subsystem 402, which may include a bus and/or other communication mechanism(s) for communicating information and/or instructions between the components of the computer system 400 over electronic signal paths. The I/O subsystem 402 may include an I/O controller, a memory controller, and at least one I/O port. The electronic signal paths are represented schematically in the drawings, such as lines, unidirectional arrows, or bidirectional arrows.

At least one hardware processor 404 is coupled to the I/O subsystem 402 for processing information and instructions. Hardware processor 404 may include, for example, a general-purpose microprocessor or microcontroller and/or a special-purpose microprocessor such as an embedded system or a graphics processing unit (GPU), or a digital signal processor or ARM processor. Processor 404 may comprise an integrated arithmetic logic unit (ALU) or be coupled to a separate ALU.

Computer system 400 includes one or more units of memory 406, such as a main memory, coupled to I/O subsystem 402 for electronically storing data and instructions to be executed by processor 404. Memory 406 may include volatile memory such as various forms of random-access memory (RAM) or other dynamic storage devices. Memory 406 may also be used for storing temporary variables or other intermediate information during the execution of instructions to be executed by processor 404. Such instructions, when stored in non-transitory computer-readable storage media accessible to processor 404, can render computer system 400 into a special-purpose machine customized to perform the operations specified in the instructions.

Computer system 400 includes non-volatile memory such as read-only memory (ROM) 408 or other static storage devices coupled to I/O subsystem 402 for storing information and instructions for processor 404. The ROM 408 may include various forms of programmable ROM (PROM), such as erasable PROM (EPROM) or electrically erasable PROM (EEPROM). A unit of persistent storage 410 may include various forms of non-volatile RAM (NVRAM), such as FLASH memory, solid-state storage, magnetic disk, or optical disks such as CD-ROM or DVD-ROM and may be coupled to I/O subsystem 402 for storing information and instructions. Storage 410 is an example of a non-transitory computer-readable medium that may be used to store instructions and data, which, when executed by the processor 404, cause the performance of computer-implemented methods to execute the techniques herein.

The instructions in memory 406, ROM 408, or storage 410 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or NoSQL, an object store, a graph database, a flat file system, or other data storage.

Computer system 400 may be coupled via I/O subsystem 402 to at least one output device 412. In one embodiment, output device 412 is a digital computer display. Examples of a display that may be used in various embodiments include a touchscreen display, a light-emitting diode (LED) display, a liquid crystal display (LCD), or an e-paper display. Computer system 400 may include other types of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to the I/O subsystem 402 for communicating signals, data, command selections, or gestures to the processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions, such as navigation in a graphical interface on a display screen, alternatively or in addition to input functions. The control device 416 may be a touchpad, a mouse, a trackball, or cursor direction keys for communicating direction information and command selections to the processor 404 and for controlling cursor movement on an output device 412, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other control device. An input device 414 may include a combination of multiple input devices, such as a video camera and a depth sensor.

In another embodiment, computer system 400 may comprise an Internet of Things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders, and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware, and interfaces for generating position reporting packets, notifications, pulse or heartbeat signals, or other recurring data transmissions that specify a position of the computer system 400, alone or in combination with other application-specific data, directed toward host computer 424 or server computer 430.

Computer system 400 may implement the techniques described herein using customized hard-wired logic, at least one ASIC or FPGA, firmware, and/or program instructions or logic which, when loaded and used or executed in combination with the computer system, cause or program the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media include, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media are distinct but may be used with transmission media. Transmission media transfer information between storage media. For example, transmission media include coaxial cables, copper wire and fiber optics, and wires comprising a bus of the I/O subsystem 402. Transmission media can also be acoustic or light waves generated during radio-wave and infrared data communications.

Various forms of media may carry at least one sequence of at least one instruction to processor 404 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 400 can receive the data on the communication link and convert the data to a format that can be read by computer system 400. For instance, a receiver, such as a radio frequency antenna or an infrared detector, can receive the data carried in a wireless or optical signal, and appropriate circuitry can provide the data to the I/O subsystem 402, such as placing the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to a bus or I/O subsystem 502. Communication interface 418 provides a two-way data communication coupling to a network link(s) 420 directly or indirectly connected to at least one communication network, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example, an Ethernet cable, a metal cable of any kind, a fiber-optic line or a telephone line. Network 422 broadly represents a local area network (LAN), wide-area network (WAN), campus network, internetwork, or any combination thereof. Communication interface 418 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic, or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may connect through network 422 to a host computer 424.

Furthermore, network link 420 may connect through network 422 or to other computing devices via internetworking devices and/or computers operated by an Internet Service Provider (ISP) 426. ISP 426 provides data communication services through a worldwide packet data communication network called the Internet 428. A server computer 430 may be coupled to the Internet 428. Server computer 430 broadly represents any computer, data center, virtual machine, or virtual computing instance with or without a hypervisor, or computer executing a containerized program system such as DOCKER or KUBERNETES. Server computer 430 may represent an electronic digital service that is implemented using more than one computer or instance and that is accessed and used by transmitting web service requests, uniform resource locator (URL) strings with parameters in HTTP payloads, API calls, app services calls, or other service calls. Computer system 400 and server computer 430 may form elements of a distributed computing system that includes other computers, a processing cluster, a server farm, or other organizations of computers that cooperate to perform tasks or execute applications or services. Server computer 430 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 430 may comprise a web application server that hosts a presentation layer, application layer, and data storage layer, such as a relational database system using a structured query language (SQL) or NoSQL, an object store, a graph database, a flat file system or other data storage.

Computer system 400 can send messages and receive data and instructions, including program code, through the network(s), network link 420, and communication interface 418. In the Internet example, server computer 430 might transmit a requested code for an application program through Internet 428, ISP 426, local network 422, and communication interface 418. The received code may be executed by processor 404 as it is received and/or stored in storage 410 or other non-volatile storage for later execution.

The execution of instructions, as described in this section, may implement a process in the form of an instance of a computer program that is being executed and consists of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share the processor 404. While each processor 404 or core of the processor executes a single task at a time, the computer system 400 may be programmed to implement multitasking to allow each processor to switch between tasks that are being executed without having to wait for each task to finish. In an embodiment, switches may be performed when tasks perform input/output operations, when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

### 6. Related Work

The approaches described in this section are approaches that could be pursued, but not necessarily approaches that have been previously conceived or pursued. Therefore, unless an approach is expressly identified as “prior art,” it should not be assumed that any of the approaches described in this section qualify as prior art merely by virtue of their inclusion in this section.

Work on reducing task-data mismatch in NMT has proposed data filtering, using surface-level heuristics Koehn et al. (2007), statistical and neural alignment and quality evaluation models Sánchez-Cartagena et al. (2018); Heffernan et al. (2022); Peter et al. (2023), language identification models Lui and Baldwin (2011); Joulin et al. (2016), or various combinations of these Koehn et al. (2020).

While data filtering techniques do help reduce the task-data mismatch, they force a trade-off between increasing task alignment and retaining flawed but potentially useful training data. To counter this, curriculum learning can be used by training first on a conservatively filtered dataset and then shifting to a cleaner subset of the data (Bogoychev et al., 2023).

However, no amount of data filtering can remove the effects of translationese, as it is present in all translations. Riley et al. (2020) and Freitag et al. (2022b) both address this by treating original and translated text as separate languages in a “multilingual” NMT model, by training either a classifier or a contrastive language model to tag each source and target segment as either original or translated. At inference time, they use their model in a zero-shot setting to translate from the original source text into the distribution of the original target text.

Similarly, Tomani et al. (2024) label each source sentence with a binned QE score. By adding the label of the highest quality bin to a source sentence at inference time, they successfully bias the model towards high-quality translations.

Ramos et al. (2024) apply Reinforcement Learning from Human Feedback (Ziegler et al., 2020) to NMT using a variety of QE metrics as reward, and compare it to data filtering and inference-time techniques such as re-ranking using a QE model and Minimum Bayes Risk decoding (MBR) Kumar and Byrne (2004); Freitag et al. (2022a), finding that a combination of data filtering, reinforcement learning, and re-ranking performs best.

In DPO MBR fine-tuning, MBR was used to generate preference pairs for use with DPO Yang et al. (2024). Compared to DQO, this method is more computationally expensive, due to the quadratic costs of MBR, and additionally requires a reference-based QE model. In addition, DQO's batched online nature ensures that preference pairs remain relevant to the policy model.

### 7. Conclusion

We demonstrate the existence of a fundamental task-data mismatch in NMT and introduce Direct Quality Optimization (DQO), an algorithm for aligning a pretrained model with human preference.

Using DQO on a multilingual NMT model, we find improvements in automatic quality metrics for all supported target languages, even those neither used for DQO nor related to the languages used for DQO. A human evaluation confirms that these improvements also lead to increased human preference.

The improvements in translation quality for unrelated languages include language-specific features that were not seen during DQO, suggesting that the baseline model had, but did not use, knowledge of those features during inference. We suggest that this is the expected behavior of a model trained with supervised learning, and present DQO as an efficient method of aligning a translation model with human preference.

### REFERENCES

Albir (2017) A. H. Albir. 2017. Researching Translation Competence by PACTE Group. Benjamins Translation Library. John Benjamins Publishing Company.
Bai et al. (2022) Yuntao Bai, Andy Jones, Kamal Ndousse, Amanda Askell, Anna Chen, Nova DasSarma, Dawn Drain, Stanislav Fort, Deep Ganguli, Tom Henighan, Nicholas Joseph, Saurav Kadavath, Jackson Kernion, Tom Conerly, Sheer El-Showk, Nelson Elhage, Zac Hatfield-Dodds, Danny Hernandez, Tristan Hume, Scott Johnston, Shauna Kravec, Liane Lovitt, Neel Nanda, Catherine Olsson, Dario Amodei, Tom Brown, Jack Clark, Sam McCandlish, Chris Olah, Ben Mann, and Jared Kaplan. 2022. Training a helpful and harmless assistant with reinforcement learning from human feedback.arXiv: 2204.05862.
Bañón et al. (2020) Marta Bañón, Pinzhen Chen, Barry Haddow, Kenneth Heafield, Hieu Hoang, Miquel Esplà-Gomis, Mikel L. Forcada, Amir Kamran, Faheem Kirefu, Philipp Koehn, Sergio Ortiz Rojas, Leopoldo Pla Sempere, Gema Ramírez-Sánchez, Elsa Sarrías, Marek Strelec, Brian Thompson, William Waites, Dion Wiggins, and Jaume Zaragoza. 2020.ParaCrawl: Web-scale acquisition of parallel corpora. In Proceedings of the 58th Annual Meeting of the Association for Computational Linguistics, pages 4555-4567, Online. Association for Computational Linguistics.
Baroni and Bernardini (2005) Marco Baroni and Silvia Bernardini. 2005. A New Approach to the Study of Translationese: Machine-learning the Difference between Original and Translated Text. Literary and Linguistic Computing, 21 (3): 259-274.
Barrault et al. (2019) Loïc Barrault, Ondřej Bojar, Marta R. Costa-jussà, Christian Federmann, Mark Fishel, Yvette Graham, Barry Haddow, Matthias Huck, Philipp Koehn, Shervin Malmasi, Christof Monz, Mathias Müller, Santanu Pal, Matt Post, and Marcos Zampieri. 2019. Findings of the 2019 conference on machine translation (WMT19). In Proceedings of the Fourth Conference on Machine Translation (Volume 2: Shared Task Papers, Day 1), pages 1-61, Florence, Italy. Association for Computational Linguistics.
Bogoychev et al. (2023) Nikolay Bogoychev, Jelmer van der Linde, Graeme Nail, Barry Haddow, Jaume Zaragoza-Bernabeu, Gema Ramírez-Sánchez, Lukas Weymann, Tudor Nicolae Mateiu, Jindřich Helcl, and Mikko Aulamo. 2023. OpusCleaner and OpusTrainer, open source toolkits for training machine translation and large language models.arXiv: 2311.14838.
Christodouloupoulos and Steedman (2015) Christos Christodouloupoulos and Mark Steedman. 2015. A massively parallel corpus: the Bible in 100 languages. Language Resources and Evaluation, 49 (2): 375-395.
Eisele and Chen (2010) Andreas Eisele and Yu Chen. 2010. MultiUN: A multilingual corpus from united nation documents. In Proceedings of the Seventh International Conference on Language Resources and Evaluation (LREC′10), Valletta, Malta. European Language Resources Association (ELRA).
El-Kishky et al. (2020) Ahmed El-Kishky, Vishrav Chaudhary, Francisco Guzmán, and Philipp Koehn. 2020. CCAligned: A massive collection of cross-lingual web-document pairs. In Proceedings of the 2020 Conference on Empirical Methods in Natural Language Processing (EMNLP), pages 5960-5969, Online. Association for Computational Linguistics.
El-Kishky et al. (2021) Ahmed El-Kishky, Adithya Renduchintala, James Cross, Francisco Guzmán, and Philipp Koehn. 2021. Xlent: Mining a large cross-lingual entity dataset with lexical-semantic-phonetic word alignment. In Proceedings of the 2021 Conference on Empirical Methods in Natural Language Processing, pages 10424-10430.
Fan et al. (2021) Angela Fan, Shruti Bhosale, Holger Schwenk, Zhiyi Ma, Ahmed El-Kishky, Siddharth Goyal, Mandeep Baines, Onur Celebi, Guillaume Wenzek, Vishrav Chaudhary, Naman Goyal, Tom Birch, Vitaliy Liptchinsky, Sergey Edunov, Edouard Grave, Michael Auli, and Armand Joulin. 2021.Beyond english-centric multilingual machine translation. J. Mach. Learn. Res., 22(1).
Fan et al. (2018) Angela Fan, Mike Lewis, and Yann Dauphin. 2018. Hierarchical neural story generation. In Proceedings of the 56th Annual Meeting of the Association for Computational Linguistics (Volume 1: Long Papers), pages 889-898, Melbourne, Australia. Association for Computational Linguistics.
Federmann et al. (2022) Christian Federmann, Tom Kocmi, and Ying Xin. 2022. NTREX-128—news test references for MT evaluation of 128 languages. In Proceedings of the First Workshop on Scaling Up Multilingual Evaluation, pages 21-24, Online. Association for Computational Linguistics.
Freitag et al. (2021) Markus Freitag, George Foster, David Grangier, Viresh Ratnakar, Qijun Tan, and Wolfgang Macherey. 2021. Experts, errors, and context: A large-scale study of human evaluation for machine translation. Transactions of the Association for Computational Linguistics, 9:1460-1474.
Freitag et al. (2022a) Markus Freitag, David Grangier, Qijun Tan, and Bowen Liang. 2022a.High Quality Rather than High Model Probability: Minimum Bayes Risk Decoding with Neural Metrics. Transactions of the Association for Computational Linguistics, 10:811-825.
Freitag et al. (2022b) Markus Freitag, David Vilar, David Grangier, Colin Cherry, and George Foster. 2022b.A natural diet: Towards improving naturalness of machine translation output. In Findings of the Association for Computational Linguistics: ACL 2022, pages 3340-3353, Dublin, Ireland. Association for Computational Linguistics.
Heffernan et al. (2022) Kevin Heffernan, Onur çelebi, and Holger Schwenk. 2022. Bitext mining using distilled sentence representations for low-resource languages. In Findings of the Association for Computational Linguistics: EMNLP 2022, pages 2101-2112, Abu Dhabi, United Arab Emirates. Association for Computational Linguistics.
Holtzman et al. (2020) Ari Holtzman, Jan Buys, Li Du, Maxwell Forbes, and Yejin Choi. 2020. The curious case of neural text degeneration. In International Conference on Learning Representations.
Joulin et al. (2016) Armand Joulin, Edouard Grave, Piotr Bojanowski, and Tomas Mikolov. 2016. Bag of tricks for efficient text classification. arXiv preprint arXiv: 1607.01759.
Junczys-Dowmunt et al. (2016) Marcin Junczys-Dowmunt, Bruno Pouliquen, and Christophe Mazenc. 2016.Coppa v2.0: Corpus of parallel patent applications. building large parallel corpora with gnu make.
Kasai et al. (2021) Jungo Kasai, Nikolaos Pappas, Hao Peng, James Cross, and Noah Smith. 2021. Deep encoder, shallow decoder: Reevaluating non-autoregressive machine translation. In International Conference on Learning Representations.
Klavinska (2021) Antra Klavinska. 2021. Transcription of foreign personal names in the written works of learners of latvian as a foreign language. Journal of Education Culture and Society, 12:469-481.
Kocmi et al. (2023) Tom Kocmi, Eleftherios Avramidis, Rachel Bawden, Ondřej Bojar, Anton Dvorkovich, Christian Federmann, Mark Fishel, Markus Freitag, Thamme Gowda, Roman Grundkiewicz, Barry Haddow, Philipp Koehn, Benjamin Marie, Christof Monz, Makoto Morishita, Kenton Murray, Makoto Nagata, Toshiaki Nakazawa, Martin Popel, Maja Popović, and Mariya Shmatova. 2023. Findings of the 2023 conference on machine translation (WMT23): LLMs are here but not quite there yet. In Proceedings of the Eighth Conference on Machine Translation, pages 1-42, Singapore. Association for Computational Linguistics.
Kocmi et al. (2024) Tom Kocmi, Vilém Zouhar, Christian Federmann, and Matt Post. 2024. Navigating the metrics maze: Reconciling score magnitudes and accuracies. In Proceedings of the 62nd Annual Meeting of the Association for Computational Linguistics (Volume 1: Long Papers), pages 1999-2014, Bangkok, Thailand. Association for Computational Linguistics.
Koehn (2005) Philipp Koehn. 2005. Europarl: A parallel corpus for statistical machine translation. In Proceedings of Machine Translation Summit X: Papers, pages 79-86, Phuket, Thailand.

Koehn et al. (2020) Philipp Koehn, Vishrav Chaudhary, Ahmed El-Kishky, Naman Goyal, Peng-Jen Chen, and Francisco Guzmán. 2020. Findings of the WMT 2020 shared task on parallel corpus filtering and alignment. In Proceedings of the Fifth Conference on Machine Translation, pages 726-742, Online. Association for Computational Linguistics.
Koehn et al. (2007) Philipp Koehn, Hieu Hoang, Alexandra Birch, Chris Callison-Burch, Marcello Federico, Nicola Bertoldi, Brooke Cowan, Wade Shen, Christine Moran, Richard Zens, Chris Dyer, Ondřej Bojar, Alexandra Constantin, and Evan Herbst. 2007. Moses: Open source toolkit for statistical machine translation. In Proceedings of the 45th Annual Meeting of the Association for Computational Linguistics Companion Volume Proceedings of the Demo and Poster Sessions, pages 177-180, Prague, Czech Republic. Association for Computational Linguistics.
Koppel and Ordan (2011) Moshe Koppel and Noam Ordan. 2011. Translationese and its dialects. In Proceedings of the 49th Annual Meeting of the Association for Computational Linguistics: Human Language Technologies, pages 1318-1326, Portland, Oregon, USA. Association for Computational Linguistics.
Kreutzer et al. (2022) Julia Kreutzer, Isaac Caswell, Lisa Wang, Ahsan Wahab, Daan van Esch, Nasanbayar Ulzii-Orshikh, Allahsera Tapo, Nishant Subramani, Artem Sokolov, Claytone Sikasote, Monang Setyawan, Supheakmungkol Sarin, Sokhar Samb, Benoît Sagot, Clara Rivera, Annette Rios, Isabel Papadimitriou, Salomey Osei, Pedro Ortiz Suarez, Iroro Orife, Kelechi Ogueji, Andre Niyongabo Rubungo, Toan Q. Nguyen, Mathias Müller, André Müller, Shamsuddeen Hassan Muhammad, Nanda Muhammad, Ayanda Mnyakeni, Jamshidbek Mirzakhalov, Tapiwanashe Matangira, Colin Leong, Nze Lawson, Sneha Kudugunta, Yacine Jernite, Mathias Jenny, Orhan Firat, Bonaventure F. P. Dossou, Sakhile Dlamini, Nisansa de Silva, Sakine çabuk Balli, Stella Biderman, Alessia Battisti, Ahmed Baruwa, Ankur Bapna, Pallavi Baljekar, Israel Abebe Azime, Ayodele Awokoya, Duygu Ataman, Orevaoghene Ahia, Oghenefego Ahia, Sweta Agrawal, and Mofetoluwa Adeyemi. 2022. Quality at a Glance: An Audit of Web-Crawled Multilingual Datasets. Transactions of the Association for Computational Linguistics, 10:50-72.
Kuchaiev et al. (2019) Oleksii Kuchaiev, Jason Li, Huyen Nguyen, Oleksii Hrinchuk, Ryan Leary, Boris Ginsburg, Samuel Kriman, Stanislav Beliaev, Vitaly Lavrukhin, Jack Cook, Patrice Castonguay, Mariya Popova, Jocelyn Huang, and Jonathan M. Cohen. 2019. Nemo: a toolkit for building ai applications using neural modules. arXiv: 1909.09577.
Kumar and Byrne (2004) Shankar Kumar and William Byrne. 2004. Minimum Bayes-risk decoding for statistical machine translation. In Proceedings of the Human Language Technology Conference of the North American Chapter of the Association for Computational Linguistics: HLT-NAACL 2004, pages 169-176, Boston, Massachusetts, USA. Association for Computational Linguistics.
La Morgia et al. (2023) Massimo La Morgia, Alessandro Mei, Eugenio Nerio Nemmi, Luca Sabatini, and Francesco Sassi. 2023. Translated texts under the lens: From machine translation detection to source language identification. In Advances in Intelligent Data Analysis XXI, pages 222-235, Cham. Springer Nature Switzerland.
Laviosa (1998) Sara Laviosa. 1998. Core patterns of lexical use in a comparable corpus of English narrative prose. Meta, 43(4):557-570.
Lison and Tiedemann (2016)⬆Pierre Lison and Jörg Tiedemann. 2016. OpenSubtitles2016: Extracting large parallel corpora from movie and TV subtitles. In Proceedings of the Tenth International Conference on Language Resources and Evaluation (LREC'16), pages 923-929, Portorož, Slovenia. European Language Resources Association (ELRA).
Lommel et al. (2014)⬆Arle Lommel, Aljoscha Burchardt, and Hans Uszkoreit. 2014. Multidimensional quality metrics (mqm): A framework for declaring and describing translation quality metrics. Tradumàtica: tecnologies de la traducció, 0:455-463.
Lui and Baldwin (2011)⬆Marco Lui and Timothy Baldwin. 2011. Cross-domain feature selection for language identification. In Proceedings of 5th International Joint Conference on Natural Language Processing, pages 553-561, Chiang Mai, Thailand. Asian Federation of Natural Language Processing.
Meng et al. (2024)⬆Yan Meng, Di Wu, and Christof Monz. 2024. How to learn in a noisy world? self-correcting the real-world data noise on machine translation.arXiv: 2407.02208.
Peter et al. (2023)⬆Jan-Thorsten Peter, David Vilar, Daniel Deutsch, Mara Finkelstein, Juraj Juraska, and Markus Freitag. 2023. There's no data like better data: Using QE metrics for MT data filtering. In Proceedings of the Eighth Conference on Machine Translation, pages 561-577, Singapore. Association for Computational Linguistics.
Phipson and Smyth (2010)⬆Belinda Phipson and Gordon K Smyth. 2010. Permutation p-values should never be zero: Calculating exact p-values when permutations are randomly drawn. Statistical Applications in Genetics and Molecular Biology, 9(1).
Post (2018)⬆Matt Post. 2018. A call for clarity in reporting BLEU scores. In Proceedings of the Third Conference on Machine Translation: Research Papers, pages 186-191, Brussels, Belgium. Association for Computational Linguistics.
Rafailov et al. (2023)⬆Rafael Rafailov, Archit Sharma, Eric Mitchell, Christopher D Manning, Stefano Ermon, and Chelsea Finn. 2023. Direct preference optimization: Your language model is secretly a reward model. In Advances in Neural Information Processing Systems, volume 36, pages 53728-53741. Curran Associates, Inc.
Ramírez-Sánchez et al. (2020)⬆Gema Ramírez-Sánchez, Jaume Zaragoza-Bernabeu, Marta Bañón, and Sergio Ortiz-Rojas. 2020. Bifixer and bicleaner: two open-source tools to clean your parallel data. In Proceedings of the 22nd Annual Conference of the European Association for Machine Translation, pages 291-298, Lisboa, Portugal. European Association for Machine Translation.
Ramos et al. (2024)⬆Miguel Moura Ramos, Patrick Fernandes, António Farinhas, and André F. T. Martins. 2024. Aligning neural machine translation models: Human feedback in training and inference.arXiv: 2311.09132.
Rei et al. (2022a)⬆Ricardo Rei, José G. C. de Souza, Duarte Alves, Chrysoula Zerva, Ana C Farinha, Taisiya Glushkova, Alon Lavie, Luisa Coheur, and André F. T. Martins. 2022a.COMET-22: Unbabel-IST 2022 submission for the metrics shared task. In Proceedings of the Seventh Conference on Machine Translation (WMT), pages 578-585, Abu Dhabi, United Arab Emirates (Hybrid). Association for Computational Linguistics.

Rei et al. (2022b)⬆Ricardo Rei, Marcos Treviso, Nuno M. Guerreiro, Chrysoula Zerva, Ana C Farinha, Christine Maroti, José G. C. de Souza, Taisiya Glushkova, Duarte Alves, Luisa Coheur, Alon Lavie, and André F. T. Martins. 2022b.CometKiwi: IST-Unbabel 2022 Submission for the Quality Estimation Shared Task. In Proceedings of the Seventh Conference on Machine Translation (WMT), pages 634-645, Abu Dhabi, United Arab Emirates (Hybrid). Association for Computational Linguistics.
Riley et al. (2020)⬆Parker Riley, Isaac Caswell, Markus Freitag, and David Grangier. 2020. Translationese as a language in “multilingual” NMT. In Proceedings of the 58th Annual Meeting of the Association for Computational Linguistics, pages 7737-7746, Online. Association for Computational Linguistics.
Rozis and Skadiņš (2017)⬆Roberts Rozis and Raivis Skadiņš. 2017. Tilde MODEL-multilingual open data for EU languages. In Proceedings of the 21st Nordic Conference on Computational Linguistics, pages 263-265, Gothenburg, Sweden. Association for Computational Linguistics.
Sánchez-Cartagena et al. (2018)⬆Víctor M. Sánchez-Cartagena, Marta Bañón, Sergio Ortiz-Rojas, and Gema Ramírez-Sánchez. 2018. Prompsit's submission to wmt 2018 parallel corpus filtering shared task. In Proceedings of the Third Conference on Machine Translation, Volume 2: Shared Task Papers, Brussels, Belgium. Association for Computational Linguistics.
Schwenk et al. (2021a)⬆Holger Schwenk, Vishrav Chaudhary, Shuo Sun, Hongyu Gong, and Francisco Guzmán. 2021a.WikiMatrix: Mining 135M parallel sentences in 1620 language pairs from Wikipedia. In Proceedings of the 16th Conference of the European Chapter of the Association for Computational Linguistics: Main Volume, pages 1351-1361, Online. Association for Computational Linguistics.
Schwenk et al. (2021b)⬆Holger Schwenk, Guillaume Wenzek, Sergey Edunov, Edouard Grave, Armand Joulin, and Angela Fan. 2021b.CCMatrix: Mining billions of high-quality parallel sentences on the web. In Proceedings of the 59th Annual Meeting of the Association for Computational Linguistics and the 11th International Joint Conference on Natural Language Processing (Volume 1: Long Papers), pages 6490-6500, Online. Association for Computational Linguistics.
Sellam et al. (2020)⬆Thibault Sellam, Dipanjan Das, and Ankur Parikh. 2020. BLEURT: Learning robust metrics for text generation. In Proceedings of the 58th Annual Meeting of the Association for Computational Linguistics, pages 7881-7892, Online. Association for Computational Linguistics.
Shen et al. (2021)⬆Jiajun Shen, Peng-Jen Chen, Matthew Le, Junxian He, Jiatao Gu, Myle Ott, Michael Auli, and Marc′Aurelio Ranzato. 2021. The source-target domain mismatch problem in machine translation. In Proceedings of the 16th Conference of the European Chapter of the Association for Computational Linguistics: Main Volume, pages 1519-1533, Online. Association for Computational Linguistics.
Smith et al. (2013)⬆Jason R. Smith, Herve Saint-Amand, Magdalena Plamada, Philipp Koehn, Chris Callison-Burch, and Adam Lopez. 2013. Dirt cheap web-scale parallel text from the Common Crawl. In Proceedings of the 51st Annual Meeting of the Association for Computational Linguistics (Volume 1: Long Papers), pages 1374-1383, Sofia, Bulgaria. Association for Computational Linguistics.
Sominsky and Wintner (2019) Ilia Sominsky and Shuly Wintner. 2019. Automatic detection of translation direction. In Proceedings of the International Conference on Recent Advances in Natural Language Processing (RANLP 2019), pages 1131-1140, Varna, Bulgaria. INCOMA Ltd.
Steinberger et al. (2006) Ralf Steinberger, Bruno Pouliquen, Anna Widiger, Camelia Ignat, Tomaz Erjavec, Dan Tufis, and Dániel Varga. 2006. The jrc-acquis: A multilingual aligned parallel corpus with 20+ languages. CoRR, abs/cs/0609058.
Team et al. (2024) NLLB Team, Marta R. Costa-jussà, James Cross, Onur çelebi, Maha Elbayad, Kenneth Heafield, Kevin Heffernan, Elahe Kalbassi, Janice Lam, Daniel Licht, Jean Maillard, Anna Sun, Skyler Wang, Guillaume Wenzek, Al Youngblood, Bapi Akula, Loic Barrault, Gabriel Mejia Gonzalez, Prangthip Hansanti, John Hoffman, Semarley Jarrett, Kaushik Ram Sadagopan, Dirk Rowe, Shannon Spruit, Chau Tran, Pierre Andrews, Necip Fazil Ayan, Shruti Bhosale, Sergey Edunov, Angela Fan, Cynthia Gao, Vedanuj Goswami, Francisco Guzmán, Philipp Koehn, Alexandre Mourachko, Christophe Ropers, Safiyyah Saleem, Holger Schwenk, and Jeff Wang. 2024. No Language Left Behind: Scaling neural machine translation to 200 languages. Nature, 630:841-846.
Thompson et al. (2024) Brian Thompson, Mehak Dhaliwal, Peter Frisch, Tobias Domhan, and Marcello Federico. 2024. A shocking amount of the web is machine translated: Insights from multi-way parallelism. In Findings of the Association for Computational Linguistics ACL 2024, pages 1763-1775, Bangkok, Thailand and virtual meeting. Association for Computational Linguistics.
Tiedemann (2012) Jörg Tiedemann. 2012. Parallel data, tools and interfaces in OPUS. In Proceedings of the Eighth International Conference on Language Resources and Evaluation (LREC'12), pages 2214-2218, Istanbul, Turkey. European Language Resources Association (ELRA).
Tirkkonen-Condit (2004) Sonja Tirkkonen-Condit. 2004. Unique items—over- or under-represented in translated language? In Translation Universals: Do they exist?, pages 177-184. Benjamins Translation Library.
Tomani et al. (2024) Christian Tomani, David Vilar, Markus Freitag, Colin Cherry, Subhajit Naskar, Mara Finkelstein, Xavier Garcia, and Daniel Cremers. 2024. Quality-aware translation models: Efficient generation and quality estimation in a single model. In Proceedings of the 62nd Annual Meeting of the Association for Computational Linguistics (Volume 1: Long Papers), pages 15660-15679, Bangkok, Thailand. Association for Computational Linguistics.
Williams and Haddow (2021) Philip Williams and Barry Haddow. 2021. The elitr eca corpus. arXiv: 2109.07351.
Wołk and Marasek (2014) Krzysztof Wołk and Krzysztof Marasek. 2014. Building subject-aligned comparable corpora and mining it for truly parallel sentence pairs. Procedia Technology, 18:126-132. International workshop on Innovations in Information and Communication Science and Technology, IICST 2014, 3-5 Sep. 2014, Warsaw, Poland.
Yang et al. (2024) Guangyu Yang, Jinghong Chen, Weizhe Lin, and Bill Byrne. 2024. Direct preference optimization for neural machine translation with minimum Bayes risk decoding. In Proceedings of the 2024 Conference of the North American Chapter of the Association for Computational Linguistics: Human Language Technologies (Volume 2: Short Papers), pages 391-398, Mexico City, Mexico. Association for Computational Linguistics.
Ziegler et al. (2020) Daniel M. Ziegler, Nisan Stiennon, Jeffrey Wu, Tom B. Brown, Alec Radford, Dario Amodei, Paul Christiano, and Geoffrey Irving. 2020. Fine-tuning language models from human preferences.arXiv: 1909.08593.

### Appendix A

### A.1 MQM Error Subcategories by Generality

TABLE 6
Multidimensional Quality Metrics error subcategories by generality.
Language-agnostic errors are those governed by a principle that can
be generalized to all language pairs, e.g., that translations should
not omit information. Language-specific errors are those that require
additional, language-specific information to generalize from one language
pair to another, e.g., correcting improper sentence structure requires
knowledge of correct vs. incorrect sentence structures for a given
language. Other errors cannot be assigned to either category.

| Language-agnostic | Language-specific | Other |
|---|---|---|
| Accuracy/Creative | Fluency/Grammar | Other |
| Reinterpretation | | |
| Accuracy/Mistranslation | Fluency/Register | Source |
| | | issue |
| Accuracy/Source | Fluency/Spelling | |
| language fragment | | |
| Accuracy/Addition | Fluency/Punctuation | |
| Accuracy/Omission | Fluency/Character encoding | |
| Fluency/Inconsistency | Style/Unnatural or awkward | |
| Terminology/Inconsistent | Style/Bad sentence structure | |
| Non-translation | Terminology/Inappropriate | |
| | for context | |
| | Locale convention/Address format | |
| | Locale convention/Date format | |
| | Locale convention/Currency format | |
| | Locale convention/Telephone format | |
| | Locale convention/Time format | |
| | Locale convention/Name format | |

### A.2 Hyperparameters Used in Experiments

TABLE 7
A list of all hyperparameters used for Direct Quality
Optimization in this paper's experiments.

| Hyperparameter | Definition | Value |
|---|---|---|
| r_{QE} | Human preference proxy model | CometKiwi22 |
| n | Number of rounds | 5 |
| m | Epochs per round | 8 |
| d | Epoch size (source sentences) | 8000 |
| α | Learning rate | 1 × 10−6 |
| β | DPO regularization factor | 0.5 |
| k | Sampled translations per source | 64 |
| K | Top-K sampling parameter | 40 |
| P | Top-P sampling parameter | 0.8 |
| ε | Preference margin | 0.005 |
| — | Batch size | 8096 |
| — | Learning rate schedule | Linear with |
| | | warmup |
| — | Learning rate warmup steps | 150 |
| — | Gradient clipping | 10 |
| | threshold (norm) | |

### A.3 Composition of the DQO Seed Dataset

As described in FIG. 1A, Direct Quality Optimization requires a seed dataset containing input samples in the source language. This dataset does not need to include references, as the policy model x0 is used to produce a diverse set of hypotheses, which are then scored under a QE model and transformed into preference pairs.

For our experiments, we used a general and varied seed dataset consisting of the English side of the following publicly available English-German datasets provided by the OPUS project Tiedemann (2012):
bible-uedin Christodouloupoulos and Steedman (2015)
CCAligned El-Kishky et al. (2020)
CCMatrix Schwenk et al. (2021b); Fan et al. (2021)
DGT v2019 (available at the time of this writing online at the internet domain ec.europa.eu via the networked path/jrc/en/language-technologies/dgt-translation-memory). The European Commission retains ownership of the data.
EBC
ELRA-W0143 (available online via the World Wide Web and the internet domain elrc-share.eu)
ELRA-W0201
ELRC-CORDIS_News (available online via the internet domain elrc-share.eu and the networked file path/repository/browse/english-french-parallel-corpus-from-cordis-project-news/e4597da00ae511e9b7d400155d026706c248250ecee54d19bef388d2a42e6d93/)
ELRC-CORDIS_Results (available online via the internet domain elrc-share.eu and the networked file path/repository/browse/german-english-parallel-corpus-from-cordis-project-results-in-brief/e70e0b920ae511e9b7d400155d026706b079d7cd7f984a98ab96380f6215f358/)
ELRC-EMEA (available online via the internet domain elrc-share.eu and the networked file path/repository/browse/bilingual-corpus-made-out-of-pdf-documents-from-the-european-medicines-agency-emea-httpswwwemaeuropaeu-february-2020-en-de/d6ce198a862611ea913100155d0267064011b731322946a6b897cf495fb6f023/). This dataset has been generated out of public content available through European Medicines Agency, available online via the internet domain via the World Wide Web at ema.europa.eu, in February 2020.
ELRC-EU_publications. This dataset was generated from public content available through the Publications Office of the European Union (OP Portal), available online via the internet domain op.europa.eu/en/home
ELRC-EUR_LEX (available online via the internet domain elrc-share.eu via the file path/repository/browse/covid-19-eur-lex-dataset-ilingual-en-mt/cf57fe82c5af11ea913100155d026706b5596d3f449a456f983bbb4e23de81a4/)
ELRC-Information_Portal (available online via the internet domain elrc-share.eu and the file path/repository/browse/information-portal-of-the-czech-president-and-czech-castle/2c11868e088b11e6b68800155d020502c402eaf049834da0bbb019049e42098c/)
ELRC-presscorner_covid (available online via the internet domain elrc-share.eu and the file path/repository/browse/covid-19-eu-presscorner-v1-dataset-bilingual-en-de/67c1519c969311ea913100155d0267063c11069dcb104114901b3160c9f7618c/)
EMEA
EUBookshop
EUConst
EuroPat (available online via the internet domain europat.net/)
GlobalVoices
GNOME
JRC-Acquis v3.0 Steinberger et al. (2006) (available online via the internet domain joint-research-centre.ec.europa.eu and the file path/language-technology-resources/jrc-acquis_en. The European Commission retains ownership of the data.
KDE4
LinguaTools-WikiTitles
MultiUN Eisele and Chen (2010)
News-Commentary Kocmi et al. (2023)
OpenSubtitles Lison and Tiedemann (2016)
ParaCrawl Bañón et al. (2020)
PHP
Tatoeba
Tilde EESC Rozis and Skadiņš (2017)
TildeMODEL Rozis and Skadiņš (2017)
WikiMatrix Schwenk et al. (2021a)
Wikimedia (available online via the internet domain dumps.wikimedia.org and the file path/other/contenttranslation/)
Wikipedia Wołk and Marasek (2014)
Wikititles Kocmi et al. (2023)
XLEnt El-Kishky et al. (2021)
As well as the following publicly available datasets which were not obtained through OPUS:
ELITR ECA Williams and Haddow (2021)
Europarl Koehn (2005)
Tilde EMA Rozis and Skadiņš (2017)
Tilde RAPID 2019 Rozis and Skadiņš (2017)
WIPO COPPA Junczys-Dowmunt et al. (2016)
WMT13 CommonCrawl Smith et al. (2013)

These datasets were also used to train the model used in Section 5.2.

### A.4 Results by Target Language

TABLE 8
Automatic quality evaluation metrics for all target languages supported by the NVIDIA Megatron model,
before and after Direct Quality Optimization (DQO), computed on both the FLORES+ and NTREX datasets.

| | | FLORES+ | | | | NTREX | | | |
|---|---|---|---|---|---|---|---|---|---|
| Model | Lang. | BLEURT | COMET | CometKiwi | BLEU | BLEURT | COMET | CometKiwi | BLEU |
| Baseline | bg | 0.8510 | 0.9016 | 0.8614 | 42.10 | 0.7893 | 0.8592 | 0.8332 | 32.85 |
| DQO | bg | 0.8658 | 0.9111 | 0.8708 | 42.84 | 0.8063 | 0.8727 | 0.8454 | 33.45 |
| Baseline | cs | 0.7852 | 0.8882 | 0.8413 | 31.79 | 0.7365 | 0.8550 | 0.8120 | 30.46 |
| DQO | cs | 0.8088 | 0.9069 | 0.8585 | 33.12 | 0.7618 | 0.8745 | 0.8325 | 30.99 |
| Baseline | da | 0.7748 | 0.8930 | 0.8409 | 45.46 | 0.7158 | 0.8554 | 0.8163 | 37.71 |
| DQO | da | 0.7986 | 0.9094 | 0.8600 | 47.94 | 0.7375 | 0.8740 | 0.8364 | 39.27 |
| Baseline | de | 0.7514 | 0.8599 | 0.8296 | 39.22 | 0.6942 | 0.8204 | 0.8059 | 31.32 |
| DQO | de | 0.7698 | 0.8731 | 0.8429 | 39.71 | 0.7227 | 0.8434 | 0.8243 | 32.11 |
| Baseline | el | 0.7407 | 0.8864 | 0.8363 | 27.72 | 0.7003 | 0.8694 | 0.8205 | 33.05 |
| DQO | el | 0.7549 | 0.8934 | 0.8425 | 27.95 | 0.7168 | 0.8803 | 0.8259 | 34.40 |
| Baseline | es | 0.7522 | 0.8576 | 0.8581 | 27.98 | 0.7363 | 0.8500 | 0.8364 | 40.87 |
| DQO | es | 0.7661 | 0.8670 | 0.8679 | 28.84 | 0.7494 | 0.8581 | 0.8471 | 41.58 |
| Baseline | et | 0.7848 | 0.8819 | 0.8450 | 26.30 | 0.7296 | 0.8461 | 0.8162 | 24.25 |
| DQO | et | 0.8159 | 0.9024 | 0.8636 | 28.21 | 0.7610 | 0.8695 | 0.8398 | 24.95 |
| Baseline | fi | 0.8039 | 0.8927 | 0.8499 | 24.28 | 0.7475 | 0.8587 | 0.8290 | 18.76 |
| DQO | fi | 0.8364 | 0.9160 | 0.8700 | 26.50 | 0.7758 | 0.8793 | 0.8485 | 19.59 |
| Baseline | fr | 0.7737 | 0.8779 | 0.8625 | 51.00 | 0.6784 | 0.8332 | 0.8414 | 37.09 |
| DQO | fr | 0.7870 | 0.8851 | 0.8679 | 51.34 | 0.6950 | 0.8446 | 0.8490 | 38.07 |
| Baseline | hi | 0.7044 | 0.7814 | 0.8167 | 35.08 | 0.6494 | 0.7380 | 0.7907 | 26.38 |
| DQO | hi | 0.7211 | 0.8032 | 0.8384 | 33.96 | 0.6730 | 0.7657 | 0.8193 | 25.69 |
| Baseline | hr | 0.8270 | 0.8989 | 0.8645 | 31.37 | 0.7740 | 0.8662 | 0.8354 | 32.08 |
| DQO | hr | 0.8407 | 0.9085 | 0.8738 | 32.46 | 0.7887 | 0.8780 | 0.8464 | 32.29 |
| Baseline | hu | 0.8565 | 0.8761 | 0.8510 | 27.32 | 0.7805 | 0.8241 | 0.8238 | 17.76 |
| DQO | hu | 0.8817 | 0.8932 | 0.8671 | 28.31 | 0.8050 | 0.8426 | 0.8432 | 18.54 |
| Baseline | id | 0.8007 | 0.9068 | 0.8401 | 46.16 | 0.7646 | 0.8820 | 0.8107 | 40.46 |
| DQO | id | 0.8128 | 0.9150 | 0.8503 | 47.41 | 0.7789 | 0.8920 | 0.8256 | 41.03 |
| Baseline | it | 0.7840 | 0.8788 | 0.8658 | 30.32 | 0.7350 | 0.8489 | 0.8321 | 36.92 |
| DQO | it | 0.7951 | 0.8859 | 0.8725 | 31.31 | 0.7557 | 0.8656 | 0.8491 | 37.90 |
| Baseline | ja | 0.6990 | 0.8943 | 0.8589 | 32.47 | 0.6221 | 0.8638 | 0.8337 | 26.95 |
| DQO | ja | 0.7158 | 0.9058 | 0.8699 | 35.00 | 0.6442 | 0.8787 | 0.8511 | 27.25 |
| Baseline | ko | 0.6592 | 0.8714 | 0.8461 | 29.63 | 0.5896 | 0.8360 | 0.8144 | 25.85 |
| DQO | ko | 0.6876 | 0.8884 | 0.8648 | 30.84 | 0.6162 | 0.8565 | 0.8362 | 27.43 |
| Baseline | lt | 0.8084 | 0.8758 | 0.8387 | 26.38 | 0.7609 | 0.8452 | 0.8126 | 21.93 |
| DQO | lt | 0.8393 | 0.8969 | 0.8577 | 28.32 | 0.7867 | 0.8637 | 0.8283 | 22.29 |
| Baseline | lv | 0.7940 | 0.8679 | 0.8269 | 31.10 | 0.7066 | 0.8139 | 0.7864 | 20.55 |
| DQO | lv | 0.8292 | 0.8906 | 0.8481 | 32.95 | 0.7528 | 0.8486 | 0.8172 | 22.05 |
| Baseline | nl | 0.7477 | 0.8619 | 0.8487 | 27.70 | 0.7154 | 0.8426 | 0.8254 | 34.54 |
| DQO | nl | 0.7665 | 0.8741 | 0.8615 | 28.55 | 0.7352 | 0.8606 | 0.8420 | 35.88 |
| Baseline | no | 0.7827 | 0.8916 | 0.8561 | 33.59 | 0.7447 | 0.8623 | 0.8270 | 36.85 |
| DQO | no | 0.7963 | 0.9017 | 0.8687 | 34.40 | 0.7651 | 0.8782 | 0.8451 | 38.87 |
| Baseline | pl | 0.7728 | 0.8736 | 0.8296 | 21.52 | 0.7136 | 0.8389 | 0.8034 | 26.32 |
| DQO | pl | 0.7951 | 0.8884 | 0.8421 | 22.52 | 0.7356 | 0.8567 | 0.8186 | 27.63 |
| Baseline | pt | 0.7894 | 0.8958 | 0.8480 | 50.45 | 0.7090 | 0.8486 | 0.8254 | 34.05 |
| DQO | pt | 0.7996 | 0.9008 | 0.8549 | 50.53 | 0.7228 | 0.8587 | 0.8355 | 35.10 |
| Baseline | ro | 0.8155 | 0.8995 | 0.8654 | 40.57 | 0.7471 | 0.8497 | 0.8346 | 33.83 |
| DQO | ro | 0.8298 | 0.9072 | 0.8738 | 41.94 | 0.7634 | 0.8637 | 0.8490 | 35.53 |
| Baseline | ru | 0.7616 | 0.8821 | 0.8434 | 32.05 | 0.6897 | 0.8408 | 0.8133 | 32.85 |
| DQO | ru | 0.7764 | 0.8929 | 0.8541 | 32.62 | 0.7087 | 0.8560 | 0.8283 | 33.07 |
| Baseline | sl | 0.8077 | 0.8725 | 0.8428 | 30.99 | 0.7250 | 0.8140 | 0.7923 | 28.53 |
| DOO | sl | 0.8343 | 0.8913 | 0.8584 | 32.32 | 0.7648 | 0.8445 | 0.8209 | 29.78 |
| Baseline | sv | 0.7997 | 0.8970 | 0.8549 | 45.30 | 0.7422 | 0.8595 | 0.8203 | 41.12 |
| DQO | sv | 0.8141 | 0.9069 | 0.8664 | 46.38 | 0.7639 | 0.8784 | 0.8408 | 42.41 |
| Baseline | tr | 0.7821 | 0.8862 | 0.8492 | 29.89 | 0.6866 | 0.8271 | 0.8164 | 17.59 |
| DQO | tr | 0.8001 | 0.8991 | 0.8631 | 30.60 | 0.7116 | 0.8466 | 0.8349 | 17.82 |
| Baseline | uk | 0.7609 | 0.8798 | 0.8318 | 29.99 | 0.6892 | 0.8361 | 0.7999 | 25.79 |
| DQO | uk | 0.7804 | 0.8930 | 0.8444 | 30.93 | 0.7154 | 0.8574 | 0.8177 | 26.88 |
| Baseline | vi | 0.7292 | 0.8775 | 0.8315 | 42.13 | 0.6787 | 0.8452 | 0.8096 | 41.42 |
| DQO | vi | 0.7488 | 0.8904 | 0.8447 | 43.19 | 0.6955 | 0.8594 | 0.8251 | 42.24 |
| Baseline | zh | 0.6948 | 0.8526 | 0.8192 | 40.09 | 0.6281 | 0.8106 | 0.7887 | 34.54 |
| DQO | zh | 0.7157 | 0.8710 | 0.8359 | 42.45 | 0.6509 | 0.8312 | 0.8093 | 36.25 |

What is claimed is:

1. A computer-implemented method, comprising:
receiving one or more seed datasets, each of the seed datasets comprising a plurality of source sentence pairs in a first language and a second translated language;
sampling the one or more seed datasets, the sampling including obtaining a plurality of source segments;
for a source segment of the plurality of source segments:
sampling a target language from among a plurality of different languages;
sampling, using a policy model, a plurality of translations into the target language;
for each of the sampled plurality of translations into the target language, determining an associated reference-free quality estimation;
constructing a plurality of preference pairs each comprising the source segment and a sampled translation of the plurality of translations by selecting a sampled translation of the plurality of translations having a highest associated reference-free quality estimation and uniformly sampling translations of the plurality of sampled translations having an associated reference-free quality estimation that is less than the highest associated reference-free quality estimation;
wherein each of the preference pairs comprises the sampled translation having the highest associated reference-free quality estimation per source segment and another translation having been uniformly sampled and having an associated reference-free quality estimation that is less than the highest associated reference-free quality estimation; and
training a machine learning policy model using a direct preference optimization model and the plurality of preference pairs.

2. The computer-implemented method of claim 1, wherein the first language is English and the second language is German.

3. The computer-implemented method of claim 1, wherein the one or more seed datasets include one or more of a bible-uedin, CCAligned, CCMatrix, DGT v2019, EBC, ELRA-W0143, ELRA-W0201, ELRC-CORDIS_News, ELRC-CORDIS_Results, ELRC-EMEA, ELRC-EU_publications, ELRC-EUR_LEX, ELRC-Information_Portal, ELRC-presscorner_covid, EMEA, EUBookshop, EUConst, EuroPat, GlobalVoices, GNOME, JRC-Acquis v3.0, KDE4, LinguaTools-WikiTitles, MultiUN, News-Commentary, OpenSubtitles, ParaCrawl, PHP, Tatoeba, Tilde EESC, TildeMODEL, WikiMatrix, Wikimedia, Wikipedia, Wikititles, or XLEnt dataset.

4. The computer-implemented method of claim 1, wherein the one or more seed datasets include one or more of a ELITR ECA, Europarl, Tilde EMA, Tilde RAPID 2019, WIPO COPPA, or WMT13 CommonCrawl dataset.

5. The computer-implemented method of claim 1, wherein the quantity of source segments comprises 8,000 source segments.

6. The computer-implemented method of claim 1, wherein the plurality of different languages includes Chinese, German, Hindi, Russian, and Spanish.

7. The computer-implemented method of claim 1, wherein the sampling of the plurality of translations into the target language uses a combined Top-K and Top-P sampling.

8. The computer-implemented method of claim 7, wherein the plurality of translations comprises 64 translations and the combined Top-K and Top-P sampling uses a K value of 40 and a P value of 0.8.

9. The computer-implemented method of claim 1, wherein the determining of the associated reference-free quality estimation includes using a tolerance parameter to mitigate noise.

10. The computer-implemented method of claim 1, wherein the plurality of preference pairs comprises less than 8,000 preference pairs.

11. The computer-implemented method of claim 1, wherein the training of the machine learning policy model is repeated for a plurality of epochs.

12. The computer-implemented method of claim 1, further comprising:
determining that a specified number of iterations of the training have not been completed;
responsive to determining that the specified number of iterations of the training have not been completed, performing a second sampling of the one or more seed datasets, the second sampling obtaining a plurality of new source segments;
for a new source segment of the plurality of new source segments:
sampling the target language from among the plurality of different languages;
sampling, using the policy model, a plurality of new translations into the target language;
for each of the sampled plurality of new translations into the target language, determining an associated reference-free quality estimation;
constructing a plurality of new preference pairs each comprising the new source segment and a sampled translation of the plurality of new translations by selecting a sampled translation of the plurality of new translations having a highest associated new reference-free quality estimation and uniformly sampling translations of the plurality of new sampled translations having an associated new reference-free quality estimation that is less than the highest associated new reference-free quality estimation;
wherein each of the preference pairs comprises the sampled translation having the highest associated reference-free quality estimation per source segment and another translation having been uniformly sampled and having an associated reference-free quality estimation that is less than the highest associated reference-free quality estimation; and
training the machine learning policy model using the direct preference optimization model and the plurality of new preference pairs.

13. The computer-implemented method of claim 1, further comprising:
receiving, from a client device, a natural language phrase in a source language;
translating, using the trained machine learning policy model, the natural language phrase into the target language; and
transmitting, to the client device, the translation of the natural language phrase into the target language.

14. The computer-implemented method of claim 13, further comprising:
receiving, from the client device, an input indicating a quality of the translation of the natural language phrase into the target language.

15. The computer-implemented method of claim 1, wherein the associated reference-free quality estimation for each of the plurality of translations indicates a proxy for human preference.

16. The computer-implemented method of claim 1, wherein the direct preference optimization model has a learning rate of 1×10⁻⁶ and a regularization factor of 0.5.
